(19) United States
(12) Patent Application Publication
(10) Pub. No.: US 2003/0237005 A1
(43) Pub. Date: Dec. 25, 2003

(54) Method and system for protecting digital objects distributed over a network by electronic mail

(76) Inventors: Yuval Bar-Or, Sunnyvale, CA (US); David A. Lordemann, Los Altos, CA (US); Daniel J. Robinson, Santa Clara, CA (US)

Correspondence Address: SCHNECK & SCHNECK, P.O. BOX 2-E, SAN JOSE, CA, 95109-0005, US

(21) Appl. No.: 10/465,365

(22) Filed: Jun. 18, 2003

Related U.S. Application Data
(60) Provisional application No. 60/390,696, filed on Jun. 21, 2002.

(51) Int. Cl. H04L 9/00

(52) U.S. Cl. 713/201; 713/182

(57) ABSTRACT

A method and system for protecting digital objects transmitted over a network. A sender creates a notification specifying an object to be delivered to a recipient as well the object's security policy and any authentication information required to access the object. The notification is sent to an object server which creates an identifier associated with the object and sends an e-mail message with the identifier to the recipient. The recipient may access the object by referencing the identifier. The object server authenticates the request for the object and redirects the request to a security server. The security server protects the object in accordance with the security policy designated by the sender and combines the object with mobile code to enforce the security policy at the recipient's computer. The protected object is sent to the recipient. When the recipient tries to access the object, the mobile code executes and instantiates the object's security policy and object controls for enforcing the security policy at the recipient. The object may only be accessed in accordance with the security policy. An audit trail of actions related to the object may also be established.

### CROSS-REFERENCE TO RELATED APPLICATION

This application claims priority from U.S. provisional application No. 60/390,696, filed Jun. 21, 2002.

### TECHNICAL FIELD

This invention is related to a method and system for protecting digital objects such as code, documents, and images that are distributed over a network using an electronic mail interface.

### BACKGROUND OF THE INVENTION

The Internet is now commonly used in the course of business to search for information and to exchange code, documents, images, etc. among collaborators, prospective business partners, and customers. The increase in business conducted on the Internet has been accompanied by increasing concern about protecting information stored or communicated on the Internet from “hackers” who can gain unauthorized access to this information and either use it for their own financial benefit or compromise the information or the system on which it is stored.

Given the enormous volume of business conducted on the Internet and the corresponding value of that business, it is imperative that the objects (including code, documents, and images—anything represented in digital form) that are stored and exchanged and the intellectual property contained within those objects are secure—i.e., they cannot be accessed by individuals or companies who have no right to them, they cannot be printed unless there is permission to do so, they cannot be edited except where that right has been conferred by the owner.

Protection of objects and object exchanges may have many components. One of these, authentication, is the process of verifying the identity of a party requesting or sending information. This is generally accomplished through the use of passwords. A drawback to this approach is that passwords can be lost, revealed, or stolen.

A stricter authentication process uses digital certificates authorized by a certificate authority. A digital certificate contains the owner's name, serial number, expiration dates, and the digital signature (data appended to a message identifying and authenticating sender and message data using public key encryption (see below)) of the issuing authority. The certificate also contains the certificate owner's public key. In public key cryptography, which is widely used in authentication procedures, individuals have public keys and private keys which are created simultaneously by the certificate authority using an algorithm such as RSA. The public key is published in one or more directories containing the certificates; the private key remains secret. Messages are encrypted using the recipient's public key, which the sender captures in a directory, and decrypted using the recipient's private key. To authenticate a message, a sender can encrypt a message using the sender's private key; the recipient can verify the sender's identity by decrypting the signature with the sender's public key.

Authorization determines whether a user has any privileges (viewing, modifying, etc.) with regard to a resource. For instance, a system administrator can determine which users have access to a system and what privileges each user has within the system (i.e., access to certain files, amount of storage space, etc.). Authorization is usually performed after authentication. In other words, if a user requests access to an object, the system will first verify or authenticate the identity of the user and then determine whether that user has the right to access the object and how that user may use the object.

Encryption may also be used to protect objects. Encryption converts a message's plaintext into ciphertext. In order to render an encrypted object, the recipient must also obtain the correct decryption key (see, for instance, the discussion of the public key infrastructure and public key cryptography above). Although it is sometimes possible to “break” the cipher used to encrypt an object, in general, the more complex the encryption, the harder it is to break the cipher without the decryption key. A “strong” cryptosystem has a large range of possible keys which makes it almost impossible to break the cipher by trying all possible keys. A strong cryptosystem is also immune from previously-known methods of code breaking and will appear random to all standard statistical tests.

Other types of security to protect the entire computer system may also be employed at the computer locations. For instance, many businesses set up firewalls in an attempt to prevent unauthorized users from accessing the business' data or programs. However, firewalls can be compromised and do not guarantee that a computer system will be safe from attack. Another problem is that firewalls do not protect the system or the system's resources from being compromised by a hostile user located behind the firewall.

Transmission of messages can also be secured. Transport Layer Security (TLS) and Secure Sockets Layer (SSL) protocols are commonly used to provide encrypted communications between servers and clients. Both these protocols are incorporated into most Web browsers and servers.

Audit trails provide protection for an object by enforcing accountability, i.e., tracing a user's activities which are either related to an object (such as a request for the object) or actually performed on an object (viewing, editing, printing, etc.) which has been transmitted. Audit trails must be secure from unauthorized alterations; for instance, unauthorized users cannot be allowed to remove evidence of their activities from an audit log. Auditing requests and actions generates a huge amount of information; therefore, any system generating audit trails must have the capability to store the information and process it efficiently.

The above-mentioned security devices may be used separately, or more commonly, in some combination. In addition to these general devices, there are other approaches to security in the prior art.

InterTrust Technologies Corporation has received several patents related to their digital rights management technology. InterTrust's Digibox (™)container technology enables the encryption and storage of information, including content and rules regarding access to that content, in a Digibox (™) container, essentially a software container. The container, along with the encryption keys, is passed from node to node in a Virtual Distribution Environment (VDE). The VDE consists of dedicated hardware or software or combination thereof. Information in the containers may only be viewed by devices incorporated in a VDE which run the appropriate Intertrust software. An audit trail may be generated, stored, and viewed within the VDE.

U.S. Pat. No. 6,487,599 “Electronic Document Delivery System in Which Notification of Said Electronic Document Is Sent a Recipient Thereof,” assigned to Tumbleweed Communications Corp., discloses an electronic delivery system in which a user sends a server a document as well as identifying a recipient or recipients of the documents. The server can send the document to the recipient or generate a URL which the recipient may use to access the document. Both the sender and recipient must run special software in order to send and retrieve documents.

U.S. Pat. No. 6;192,407 “Private, Trackable URLs for Directed Document Delivery,” assigned to Tumbleweed Communications Corp., discloses a system in which a server, which is storing a document, generates a private URL (PURL) which identifies an intended recipient of a document as well as other parameters (such as authentication, access, etc.) specific to the delivery process. The server sends the URL to the recipient, who then uses the PURL to retrieve the document. When the recipient retrieves the document, the server customizes the retrieval based on attributes included in the PURL. The document's original formatting is preserved. This system also permits log data about access to documents to be tracked.

U.S. Pat. No. 6,385,655 “Method and Apparatus for Delivering Documents over an Electronic Network,” assigned to Tumbleweed Communications Corp., discloses a method and system similar to U.S. Pat. No. 6,192,407, discussed above, about secure document delivery which preserves the document's original formatting but discloses more information about the user interface (an application window which allows the user to choose which documents are to be protected and what level of protection they should receive).

U.S. Pat. No. 6,061,448 “Method and System for Dynamic Server Document Encryption,” assigned to Tumbleweed Communications Corp., discloses a method and system for providing secure document delivery over a wide area network. A sender directs a delivery server to retrieve an intended recipient's public key. The sender encrypts the document using a secret key, which is subsequently encrypted using the recipient's public key. The encrypted document and the encrypted secret key are then uploaded to the delivery server. The delivery server then transmits the encrypted document and the encrypted secret key to the intended recipient, which uses its private key to decrypt the secret key, which is used to decrypt the document. In other embodiments, the sender can send the encrypted document directly to the intended recipient or the sender can transmit the document to the delivery server for encryption, after which the delivery server transmits both encrypted document and the encrypted secret key to the intended recipient.

U.S. Pat. No. 6,151,675 “Method and Apparatus for Effecting Secure Document Format Conversion,” assigned to Tumbleweed Communications Corp., discloses a method and apparatus for enabling secure delivery of documents in a variety of formats. The document is encrypted with the public key of a server associated with the recipient, which is behind a firewall, of the document. The encrypted document is sent to the server within the firewall. The server decrypts the document with its private key and the document is converted to a new representation. The document can then be: forwarded to the recipient inside the firewall; reencrypted with the public key of the intended recipient outside the firewall; or reencrypted with the public key of another server associated with the intended recipient of the document.

U.S. Pat. No. 5,790,790 “Electronic Document Delivery System in Which Notification of Said Electronic Document Is Sent to a Recipient Thereof,” assigned to Tumbleweed Communications Corp., discloses a system and method for an electronic delivery system. A document is forwarded to a remote server, which then sends an e-mail notification about the document to an intended recipient, which then downloads the document using the recipient's local protocols.

U.S. Pat. Nos. 6,289,450. “Information Security Architecture for Encrypting Documents for Remote Access While Maintaining Access Control” and 6,339,825 “Method of Encrypting Information for Remote Access While Maintaining Access Control,” assigned to Authentica, Inc., disclose a system and method for protecting documents in a network. An authoring tool encrypts a document using a key from a remote server. A viewing tool decrypts the encrypted document using a decryption key obtained from the remote server and subsequently destroys the decryption key. The remote server generates encryption keys, maintains decryption keys for registered encrypted documents, authenticates requests to view the documents, grants access to the documents by providing decryption keys, etc. The remote server maintains a database of encryption keys, associated decryption keys, access policies, etc. An audit trail of requests to view documents and obtain decryption keys may be established at the remote server.

U.S. Pat. No. 6,314,425 “Apparatus and Methods for Use of Access Tokens in an Internet Document Management System,” assigned to Critical Path, discloses a system and method of managing electronic documents by using access tokens. A server generates access tokens and provides document services. The access token is a security code which restricts a user's access to an electronic document. A database at the server contains information about documents, users, and their accounts. When a document is added to the “store” at the server, notification is sent to users that the document is available. The user may request the document subject to access rights determined by the access token.

There is a need for a method and system that will protect objects (basically, anything which may be represented in digital form), including code, documents, images, and software programs, that are distributed over a network without requiring recipients to run special software on their computers in order to access protected information. A secure audit trail to ensure accountability and non-refutability is also desirable. It is also desirable to pass the protection duties, including storing the audit trail, to a third party in order to relieve the object server of both the processing and hardware of providing all security measures (including having enough memory to store a voluminous audit trail). Finally, it would be desirable to store information such as the request, authentication, authorization, serialization of the requested object, security policy of the requested object, nonce of the requested object, and a description of the protected object in the audit trail to provide comprehensive protection and demonstrate the integrity and irrefutability of the audit trail.

### SUMMARY OF THE INVENTION

This need has been met with a method and system that provides a method and system for protecting objects distributed in a network by ensuring the object is distributed only to designated recipients and restricting certain operations (i.e., viewing, printing, editing, copying) on the objects by certain recipients.

A sending device (“sender”) is a computing device that runs protection software that operates in conjunction with standard e-mail software, such as Microsoft Outlook (™). The user at the sending device uses the protection software to specify a security policy for a particular object and the recipient(s) for that object. The sender may also specify authentication information, such as a password that a recipient would have to know in order to access the object. This notification is then sent, along with the attached object, in an e-mail message via a secure connection to an object server.

The object server also runs protection software as well as having e-mail capabilities. The object server also has storage for keeping the object sent to it by the sender. The object server creates an identifier, or URL, associated with the object and sends the identifier and any authentication information provided by the sender to the recipient via an e-mail message.

The recipient device (“recipient”) is another computing device that is not required to run any protection software. All the recipient needs is an e-mail program and a Web browser such as Netscape Navigator (™) or Internet Explorer. The recipient may request the object by referencing the identifier.

The recipient's request is directed to the object server, which verifies the identity of the recipient and, where appropriate, also requests authentication information. If the recipient provides the correct authentication information (which may be provided to the recipient either in the e-mail message containing the identifier or through other means such as another e-mail message, a letter, a telephone call, etc.), the object server creates an enhanced request (an object comprising cryptographically-protected data including authentication, time of the original request, serialization, nonce, security policy, and a description of the requested object) and redirects the request to a security server.

The security server is also equipped with protection software and e-mail capabilities (for instance, an SMTP mail server may work with the security server). Once the security server receives the redirected request, it obtains the requested object, either from the object server via a secure connection, or, if the object has been requested before, from storage associated with the security server. The security server then processes the object such that it is protected according to the security policy. The object is encrypted using strong and non-malleable encryption and combined with mobile code (software sent from remote systems, transferred across a network, and downloaded and executed on a local system without explicit installation or execution by the recipient), a security policy with authentication contained in the enhanced request, and object controls, which are used to enforce the security policy. This resulting package is sent to the recipient, for instance, via HTTP(S).

The mobile code is executed at the recipient device upon receipt of the object, instantiating the security policy and object controls at the recipient device. The mobile code will execute tests to ensure proper instantiation of the object controls; when these controls are properly instantiated, the recipient may request a decryption key which is sent via secure transmission to the recipient upon satisfactory authentication of the request. The decryption keys may be one-time keys which may be used only for decrypting the specific object in question; in other embodiments, the same key may be delivered to all requesters requesting the object. If the mobile code executes successfully and a decryption key is obtained, the requested object is rendered subject to the constraints of the security policy and object controls.

A descriptor of any actions involving the sender, object server, security server, and recipient's activities with regard to the object is recorded in a logfile available for review by authorized individuals such as the security system's administrator and the content owner. This logfile, which may be a flat file, files distributed across various platforms, or embodied in a database, tape drives, line printer, or any combination thereof, may be used to construct an audit trail detailing who requested which objects, whether the objects were delivered, what type of security policy was in place for each of these objects, and any actions taken on the object by the recipient, as well as derived information such as the time an object was accessed, the number of times an object was accessed, etc.

### BRIEF DESCRIPTION OF THE DRAWINGS

FIG. 1 is a block diagram of the components of an object protection system in accordance with the invention.

FIG. 2a is a flow chart showing how an object delivered over a network is protected in accordance with the invention.

FIG. 2b is a flow chart showing how an object delivered over a network is protected in accordance with the invention.

FIG. 3a is a flow chart showing how a recipient's actions on an object delivered over a network are recorded to a logfile at the security server.

FIG. 3b is a flow chart showing how a security server's actions on an object delivered over a network are recorded to a logfile at the security server.

### DETAILED DESCRIPTION OF THE INVENTION

Application Ser. No. 09/952,290, filed Sep. 13, 2001 by Lordemann et al., application Ser. No. 09/952,696, filed Sep. 14, 2002 by Lordemann et al., and application Ser. No. 10/279,378, filed Oct. 23, 2002 by Lordemann et al. are hereby incorporated by reference.

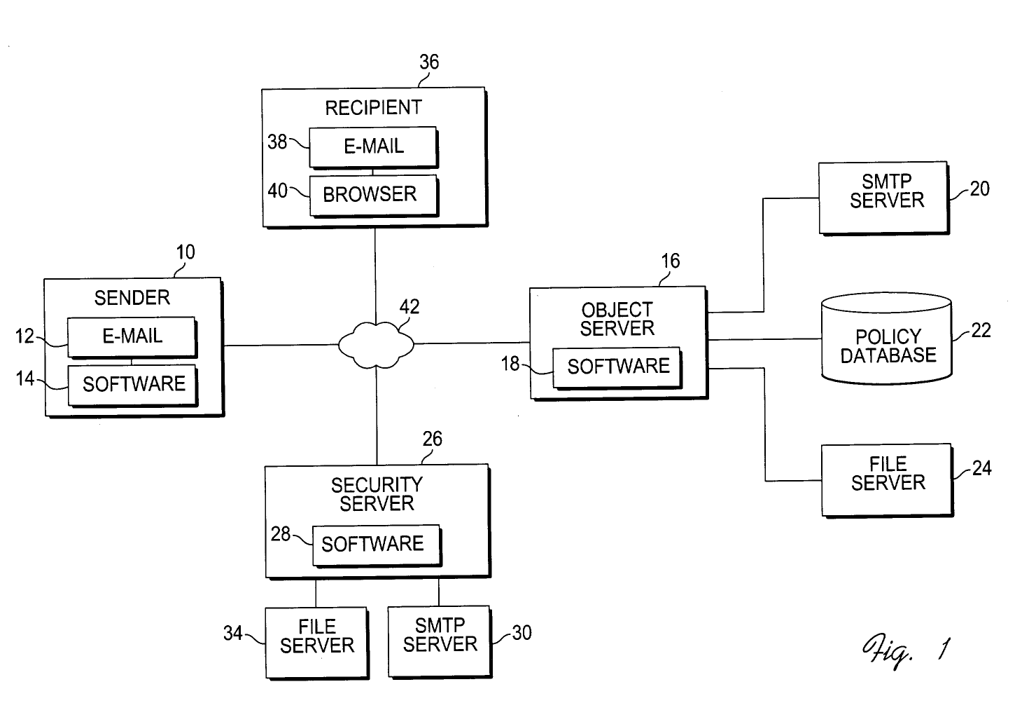

With reference to FIG. 1, a sending device (“sender”) 10, such as a computer, connected to a network 42, such as the Internet, is running an e-mail software program 12, such as Microsoft Outlook (™), in association with protection software 14 for providing protection services for an object. The object may be stored at the sending device 10 or the object server 16. A user at the sending device determines recipients 36 for the object along with a security policy and any authentication information, such as a password, for the object using the protection software 14. The security policy may include restrictions on who may view the object, the lifetime of the object (temporal restrictions), the number of times object may be viewed (cardinal restrictions), as well as action policies relating to whether the object may be printed, edited, etc. This information, or notification, is sent to the object server 16 via an e-mail message sent via secure transmission by the e-mail software program 12. If the sender is storing the object, the object is attached to the e-mail notification.

The object server 16, a hypertext transfer protocol (http) server, is also connected to the network 42 and runs protection software 18 (an extension of the http software) to provide protection services for the object. When the e-mail notification is received from the sender 10, the security policy, authentication information, and any attached object are extracted by the software 18 and stored either in a local cache or, as in this embodiment, in a policy database 22 and, in the case of the object, at a file server 24 connected to the object server 16.

The object server 16 software 18 creates an identifier, such as a URL, for the object and sends the identifier and any authentication information that the sender's notification specified should be sent to recipients 36 in an e-mail message. The object server has e-mail capabilities either in the form of software running at the object server or an SMTP server 20 associated with the object server 16.

The receiving device (“recipient”) 36, also connected to the network 42, does not need to run specialized protection software. The recipient 36 must be running an e-mail program 38 and a Web browser 40, such as Netscape Navigator™ or Microsoft Internet Explorer. When the user at the recipient device 36 reviews the e-mail message, the user may retrieve the object by referencing the identifier (i.e., clicking on the URL). The request is directed to the object server 16. Requests are relayed by the browser 40 to the object server 12 via http requests (similarly, replies to requests conform to the http protocol).

When the object server 16 receives the request from the recipient, it authenticates the request. This may be achieved by prompting the recipient 36 to provide a password. This password may be supplied to the recipient in the original notification; the password could be supplied by other means, such as a letter, another e-mail, a phone call, etc. The protection software 18 then creates an enhanced request that is included in a reply to the to the request and is subsequently, and transparently, redirected to the security server 26.

The enhanced request is an object comprising cryptographically-protected data including authentication and time of the original request as well as serialization (ensuring only one approved version of an object is available), nonce, security policy, and a description of the requested object bound together to prevent alteration. Cryptographic protection provides a variety of services. It can protect the integrity of a file (i.e., prevent unauthorized alterations) as well as assisting with the authentication and authorization of a request. The use of cryptographic protection here also protects the privacy of the recipient. Other uses for cryptographic protection include non-repudiation and detecting alterations. Cryptographic protection includes encryption. Protocols supporting both strong and non-malleable encryption are used. (Protocols determine the type of encryption used and whether any exchanges between the recipient and security server are necessary before decryption takes place (for example, a key may need to be exchanged so the recipient can decrypt an object encrypted at the security server (see below)).) A shared key for cryptographically protecting the enhanced request is present at both the object and security servers 16, 26. The key is instantiated when the protection software 18 is installed on the object server 16. In one embodiment, the key is generated when the protection software 18 is installed on the object server 16. In other embodiments, the security server 26 protection software 28 generates the key or the key may come from a certificate purchased from a third party.

The security server 26 is also an http server. After processing the enhanced request, the protection software 28 (an extension of the http software) at the security server 26 obtains the requested object either from the content server 16 (or its associated file server 24) or, if the object has been requested previously, from local storage at the security server 26 or an associated file server 34. The object is then protected according to the security policy. The security server 26 software 28 may protect a single object or an aggregation of objects; for instance, an HTML file and its inclusions may be combined into a single protected object. The object may be encrypted using strong and non-malleable encryption and then combined with mobile code (software sent from remote systems, transferred across a network, then downloaded and executed on a local system without explicit installation or execution by the recipient), the security policy contained in the enhanced request, and object controls to enforce the security policy. The resulting package is then delivered to the recipient 36 where, as will be explained in greater detail below, the mobile code is executed, instantiating the security policy and the object controls at the recipient 36 such that the object may be accessed only according to the security policy.

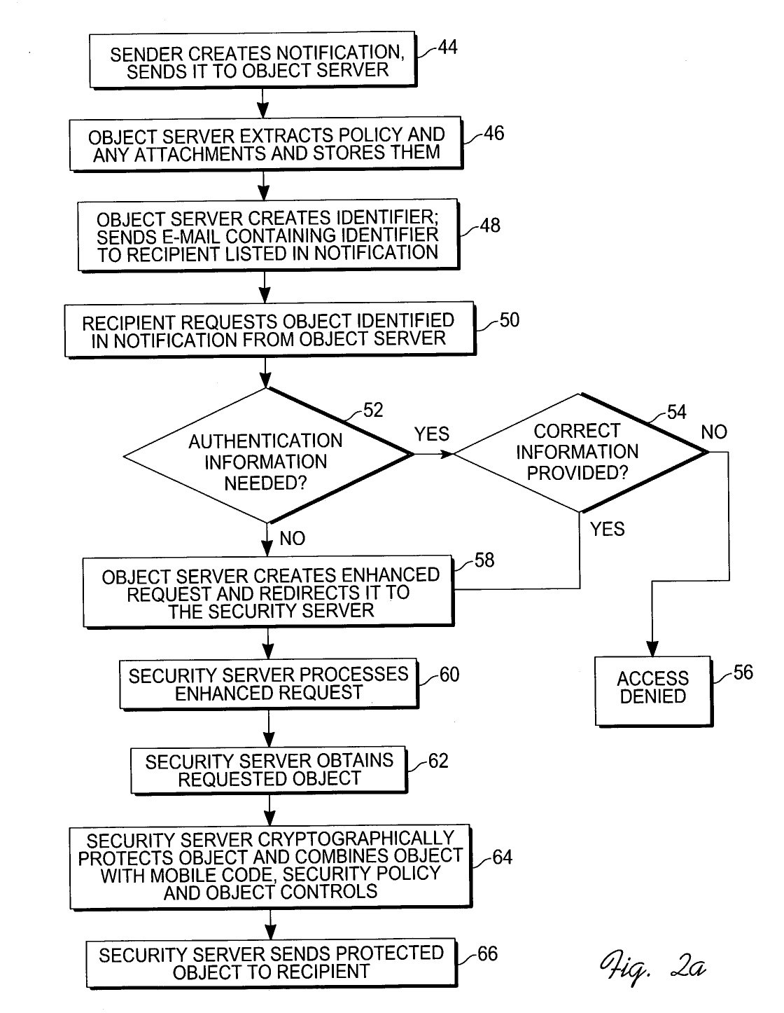

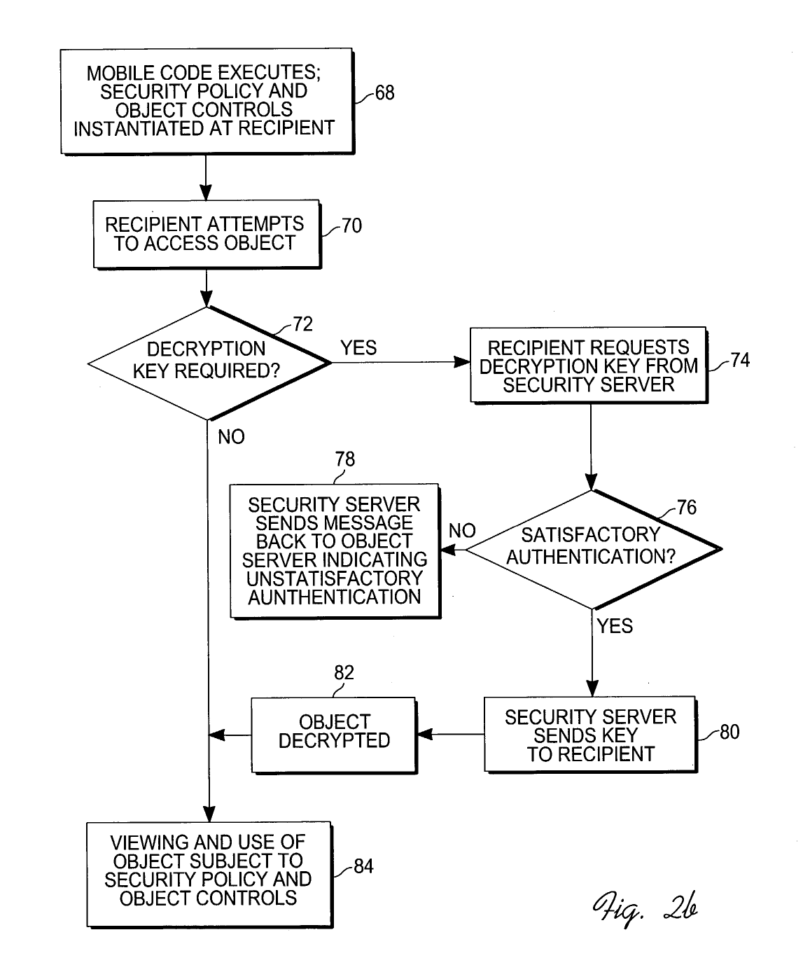

With reference to FIG. 2a, protection of an object to be distributed via e-mail begins when the sender creates a notification consisting of an identification of an object to be protected and distributed, at least one recipient of the object, any authentication information which may be necessary to access the object, and a security policy for the object. After the notification is created, it is sent via e-mail to the object server (block 44).

The object server extracts any attachments (such as the object) and the policy and stores them either at the object server or in storage associated with the object server (block 46). The object server protection software then creates an identifier, such as a URL, for the object and sends an e-mail message containing the identifier to the recipient listed in the notification (block 48). As noted above, this e-mail message, in addition to notifying the recipient that the object may be accessed, may also include authentication information specified by the sender that may be required to access the object.

After receiving the e-mail message from the object server, the recipient may request the object by referencing the identifier (for instance, clicking on the URL) in the e-mail message (block 50). When the request is received at the object server, the object server may prompt the recipient to provide any required authentication information (block 52); the object server may also have an independent authentication policy that it executes upon receiving a request. If incorrect authentication information is provided (block 54), access is denied (block 56). However, if correct authentication information is provided (block 54), or no authentication information was necessary (block 52), the object server creates an enhanced request (described above in FIG. 1) for the object which is transparently redirected to the security server (block 58).

The security server processes the enhanced request (block 60). As noted above, a shared key for cryptographically protecting the enhanced request is present at both the object and security servers. The security server will first determine whether the enhanced request meets the requirements for a well-formed (i.e., valid) request. Provided the request is valid, the security server will authenticate the request by comparing the time and authentication in the redirected request heading with those contained in the enhanced request. If the request is either invalid or cannot be authenticated, the security server may send a message back to the object server indicating an invalid or unauthenicated request.

If the request is both valid and authenticated, the security server will obtain the requested object either from local storage or from the object server via a secure transmission (block 62). The security server then cryptographically protects the object and combines it with mobile code, the security policy with the authentication contained in the enhanced request, and object controls for enforcing the security policy (block 64). The security server then sends the resulting package to the recipient, for instance by HTTP(S) (block 66).

With reference to FIG. 2b, when the recipient attempts to download the object, the mobile code executes and the object's security policy and object controls are instantiated at the recipient (block 68). The mobile code executes tests to ensure the object controls were properly instantiated. When the recipient tries to access the object (block 70), a decryption key may be required (block 72). If a key is required, and the object controls have been properly instantiated, the recipient may request an encryption key from the security server (block 74). The security server protection software then authenticates the request (block 76). If the request cannot be authenticated (block 76), the security server may send a message back to the object server indicating unsatisfactory authentication (block 78). If authentication is satisfactory (block 76), the security server sends the decryption key to the recipient (block 80) and the object is decrypted (block 82). (In one embodiment, the key used by the security server to encrypt/decrypt the object is a one-time key. The one-time key is provided either by a “seed” for randomly generating the key which is determined at the installation of the security server protection software or by other means known in the prior art, the most common being certificates.) Once the object is decrypted (block 82), or if no encryption key was required (block 72), the object may be viewed and manipulated subject to the security policy and the object controls used to enforce the security policy (block 84).

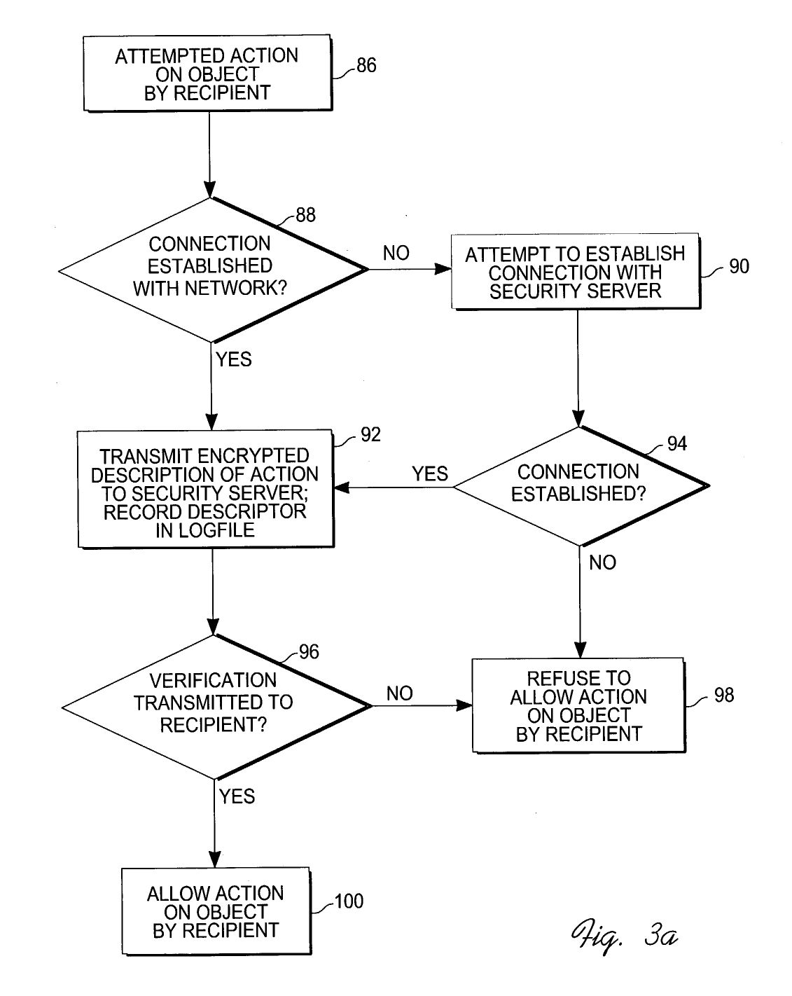

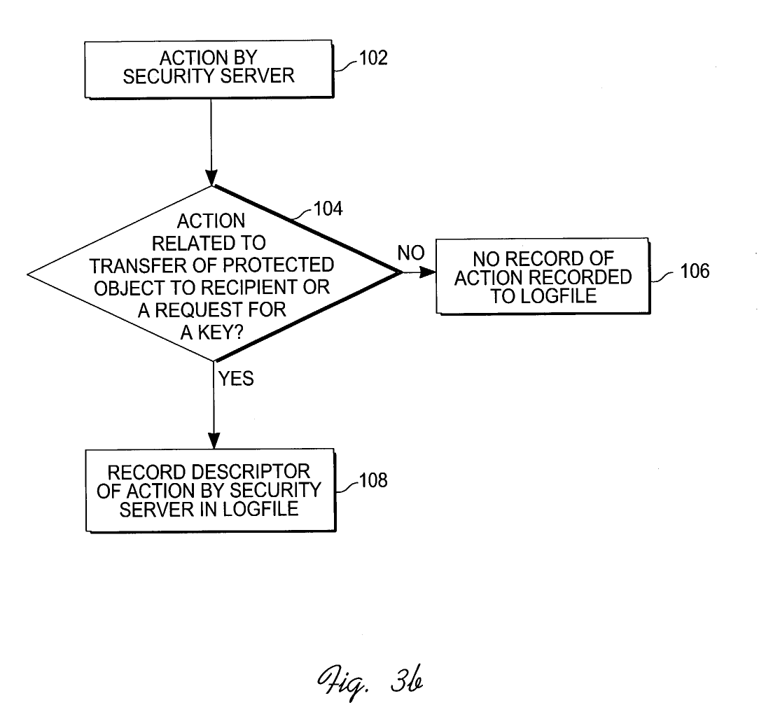

As shown in FIG. 3a, in one embodiment of the invention, a logfile of actions taken on the object by the recipient (and, as will be shown in FIG. 3b, actions taken by the security server) is maintained for the purpose of establishing an audit trail. The logfile, which may be a flat file, files distributed across various platforms, or embodied in a database, tape drives, line printer, or any combination thereof or some other storage media, is available for review by the security server's system administrator. The logfile may be used to construct an audit trail detailing who received what objects, what type of security policy was in place for each of those objects, and what actions were performed on the objects after they were delivered to recipients.

If the recipient attempts any action related to the object (i.e., viewing, printing, editing, etc.) (block 86), the object controls at the recipient will determine whether there is an established connection to a network (block 88). If there is an open connection, a cryptographically-protected descriptor of the action (created by the object controls) will be transmitted to the security server, which will record the descriptor along with some other data in a logfile (block 92). The other material recorded to the logfile also includes “local data,” i.e., data present at the server including the local time and the identity of the server, time, and the recipient's network IP address. Once the information is transmitted to the security server (block 92) and verification is transmitted to the recipient (block 96), the action on the object is allowed (block 100); conversely, if no verification is transmitted to the recipient (block 96), the action on the object is not allowed (block 98).

If there is no secure established connection with the network (block 88), the object controls will attempt to establish such a connection to the security server (block 90). If the connection is established (block 90), a cryptographically-protected descriptor of the action will be transmitted to the security server, which will record the descriptor and the other data discussed above in a logfile (block 92). The attempted action on the object is then allowed (block 100). However, if a connection to the security server cannot be established (block 94) the action on the object is not allowed (block 98).

Referring to FIG. 3b, the security server also records to a logfile descriptors of actions it takes with regard to a protected object. These actions include responding to requests for objects, sending the object to the recipient, receiving requests for decryption keys, and sending a decryption key to the recipient. When the security server performs an action (block 102), protection software determines whether that action is related to the transfer of a protected object or a request for a decryption key (block 104). If the action is not related to the transfer of a protected object or a request for a decryption key, nothing is recorded to the logfile (block 106). However, when the action is related to either a protected object or a decryption key, a descriptor of the action, along with time, local data, and the network IP address of the recipient, is recorded to a logfile (block 108). For example, when the security server receives an enhanced request for a protected object, the security server saves the enhanced request to the logfile. In addition, at least time, local data, and the network IP address of the recipient are saved.

In another embodiment, the recipient may take actions on the object while “untethered” (i.e., not connected to the security server). Provided the security policy allows untethered activity, the recipient's actions are recorded at the recipient device and then sent to the security server when the recipient establishes a connection to the security server. Controls may be set such that access to the object is further restricted if a connection to a network is not established within a set time frame.

In yet another embodiment, the descriptors of the security server's actions may be cryptographically protected before they are written to the logfile. This embodiment may be used when persons other than the system administrator are allowed access to the logfile.

1. In a communications network, a system for protecting objects delivered within the network comprising:
a) a sending device connected to the network, the sending device configured by software running at the sending device to identify a security policy for an object and the recipient of the object;
b) a recipient device connected to the network, the recipient device configured by software running at the recipient device to request and receive an object;
c) an object server connected to the network, the object server configured by software running at the object server to store the object and to respond to the request from the recipient; and
d) a security server connected to the network, the security server configured by software running at the security server to protect the object such that it may be accessed only according to the security policy after it is sent to the recipient device.

2. The system of claim 1 further comprising the sending device configured by software running at the sending device to send a notification of the security policy and the recipient of the object to the object server.

3. The system of claim 2 further comprising the sending device configured by software running at the sending device to send the object to the object server as an attachment to the notification.

4. The system of claim 2 further comprising the sending device configured by software running at the sending device to identify an authentication policy and send it to the object server with the notification.

5. The system of claim 1 further comprising the object server configured by software running at the object server to store the object received from the sending device.

6. The system of claim 1 further comprising the object server configured by software running at the object server to create an identifier for the object.

7. The system of claim 6 further comprising the object server configured by software running at the object server to send a message including the identifier to access the object to the recipient device.

8. The system of claim 1 further comprising the object server configured by software running at the object server to authenticate a request for the object from the recipient device.

9. The system of claim 1 further comprising the object server configured by software running at the object server to redirect a request for the object to the security server.

10. The system of claim 9 further comprising the object server configured by software running at the object server to create an enhanced request for the object, where the enhanced request is redirected to the security server.

11. The system of claim 10 where the enhanced request is a second object including at least one of the following:
a) cryptographically-protected authentication of the original request for the requested object;
b) cryptographically-protected time of the original request for the requested object;
c) cryptographically-protected serialization of the protected object; and
d) cryptographically-protected security policy for the requested object.

12. The system of claim 1 further comprising the security server configured by software running at the security server to retrieve the object.

13. The system of claim 12 wherein the object may be retrieved from any one of the following:
a) the object server;
b) storage associated with the object server;
c) storage associated with the security server.

14. The system of claim 1 further comprising the security server configured by software running at the security server to combine the object with mobile code, the security policy, and object controls.

15. The system of claim 1 further comprising the security server configured by software running at the security server to encrypt the object.

16. The system of claim 1 further comprising the security server configured by software running at the security server to send the protected object to the recipient device.

17. The system of claim 1 further comprising the security server configured by software running at the security server to establish an audit trail of actions relating to the object.

18. The system of claim 1 further comprising the security server configured by software running at the security server to send a decryption key to the recipient following an authenticated request from the recipient for the decryption key.

19. In a communications network, a system for protecting objects delivered in the network, the system comprising:
a) a sending device having a first e-mail program and a first software program in association with the first e-mail program, the first software program having means for designating at least one of the following:
i) a security policy for an object,
ii) at least one recipient of the object;
iii) authentication information required in order to access the object, where the designations made by the first software program are sent via an e-mail message to the object server;
b) the object server in network connection with the sending device, the object server having a second e-mail program and a second software program in association with the second e-mail program, the second software program having means for doing at least one of the following:
i) creating an identifier associated with the object;
ii) authenticating a request for an object; and
iii) redirecting an authenticated request for an object to a security server;
iv) storing any attachments from the e-mail message from the sending device at the object server;
where the object server sends an e-mail message containing the identifier associated with the object to the at least one recipient designated by the first software program and receives a request from the recipient for the object which is redirected to the security server after authentication of the request;
c) the security server in network connection with the object server, the security server having a third e-mail program and a third software program in association with the third e-mail program, the third software program having means for doing at least one of the following:
i) obtaining the object from the object server;
ii) obtaining the object from local storage;
iii) combining the object with mobile code, the security policy, and object controls; and
iv) encrypting the object; and
d) a recipient device in network connection with the object server, the recipient device having a fourth e-mail program and a browser in association with the e-mail program, where the recipient device receives the e-mail message from the object server and requests the object from the object server by referencing the identifier.

20. The system of claim 19 further comprising the second software program at the object server having means for creating an enhanced object, where the enhanced request is sent to the security server.

21. The system of claim 20 where the enhanced request is a second object including at least one of the following:
a) cryptographically-protected authentication of the original request for the requested object;
b) cryptographically-protected time of the original request for the requested object;
c) cryptographically-protected serialization of the protected object; and
d) cryptographically-protected security policy for the requested object.

22. The system of claim 19 further comprising means for establishing an audit trail of actions taken on the object.

23. A method for protecting objects delivered in a network comprising:
a) designating a security policy for an object and at least one recipient to receive the object;
b) sending a first notification specifying the security policy for and at least one recipient of the object to an object server;
c) creating an identifier for the object;
d) sending a second notification containing the identifier to the at least one recipient;
e) requesting the object using the identifier;
f) redirecting the request for the object to a security server;
g) protecting the object according to the security policy; and
h) sending the object to the requesting recipient, where the object may be accessed only according to the security policy.

24. The method of claim 23 further comprising sending the object with the first notification to the object server.

25. The method of claim 23 further comprising creating an enhanced request for the object.

26. The method of claim 23 further comprising redirecting the enhanced request to the security server.

27. The method of claim 19 further comprising providing authentication information after requesting the object.

28. The method of claim 25 further comprising redirecting the request only when correct authentication information is provided.

29. The method of claim 23 further comprising the security server obtaining the object from any one of the following:
a) the object server;
b) storage associated with the object server; and
c) storage associated with the security server.

30. The method of claim 23 further comprising protecting the object by combining it with mobile code, the security policy, and object controls.

31. The method of claim 23 further comprising protecting the object by encrypting the object.

32. The method of claim 23 further comprising protecting the object by establishing an audit trail of actions relating to the object.

33. The method of claim 23 further comprising delivering a decryption key for the object after receiving an authenticated request for the key.

34. A method for protecting objects delivered in a network comprising:
a) designating a security policy for an object and at least one recipient to receive the object, the designation performed at a sending device;
b) creating an identifier for the object at an object server;
c) requesting the object using the identifier;
d) protecting the object according to the security policy at a security server, the protection including combining the object with mobile code, the security policy, and object controls; and
e) sending the object to the requesting recipient, where the object's security policy and object controls are instantiated at the recipient device and the object may be accessed only according to the security policy.

35. The method of claim 34 further comprising sending the object with the designated security policy and recipient to the object server.

36. The method of claim 34 further comprising sending a message containing the identifier to the recipient.

37. The method of claim 34 further comprising providing authentication information after requesting the object.

38. The method of claim 37 further comprising redirecting the request to the security server when correct authentication information is provided.

39. The method of claim 38 further comprising creating an enhanced request for the object.

40. The method of claim 38 further comprising redirecting the enhanced request to the security server.

41. The method of claim 34 further comprising the security server obtaining the object from any one of the following:
a) the object server;
b) storage associated with the object server; and
c) storage associated with the security server.

42. The method of claim 34 further comprising protecting the object by encrypting it.

43. The method of claim 34 further comprising establishing an audit trail for actions relating to the object.

44. The method of claim 34 further comprising delivering a decryption key for the object after receiving an authenticated request for the key.
